(19) United States
(12) Patent Application Publication
(10) Pub. No.: US 2015/0329108 A1
(43) Pub. Date: Nov. 19, 2015

(54) DRIVING ASSISTANCE DEVICE AND DRIVING ASSISTANCE METHOD

(71) Applicant: Takahiro KODAIRA, Machida-shi (JP)

(72) Inventor: Takahiro KODAIRA, Machida-shi (JP)

(73) Assignee: TOYOTA JIDOSHA KABUSHIKI KAISHA, Toyota-shi, Aichi (JP)

(21) Appl. No.: 14/442,436

(22) PCT Filed: Dec. 11, 2012
(86) PCT No.: PCT/JP2012/082110

§ 371 Date: May 13, 2015

(51) Int. Cl. B60W 30/02; B60W 10/18; B60W 10/20

(52) U.S. Cl. CPC B60W 30/02; B60W 10/20; B60W 10/18; B60W 2550/142; B60W 2550/146; B60W 2520/14

(57) ABSTRACT

A driving assistance device includes: a travelable region detecting device which detects a travelable region of a vehicle; a travel control device which executes trajectory control by at least one of steering control and acceleration/deceleration control based on a target trajectory generated such that the vehicle travels in the travelable region detected by the travelable region detecting device; and a control device which improves control accuracy of the steering control so as to improve a property of following the target trajectory at a time the acceleration/deceleration control is required as compared to a case in which the acceleration/deceleration control is not required at a time of execution of the trajectory control by the travel control device.

### FIELD

The present invention relates to a driving assistance device and a driving assistance method.

### BACKGROUND

Conventionally, there is technology to perform trajectory control to allow a vehicle to travel along a target trajectory.

For example, Patent Literature 1 discloses technology of, in a travel assistance device which performs lane keeping assist (LKA) by using an electronic control power assisted steering (EPS) device and a variable gear ratio steering (VGRS) device, outputting an LKA target angle by one of the EPS device and the VGRS device and outputting a control amount according to this output by the other of them. Patent Literature 2 discloses technology in which vehicle deviation preventing technology and vehicle speed control cooperate with each other. Patent Literature 3 discloses technology of visually notifying a driver of a state of automatic steering control and a state of automatic acceleration/deceleration when the automatic steering control and the automatic acceleration/deceleration control are executed.

### CITATION LIST

### Patent Literature

Patent Literature 1: International Publication Pamphlet No. WO 2010/073400

Patent Literature 2: Japanese Laid-open Patent Publication No. 2007-230525

Patent Literature 3: Japanese Laid-open Patent Publication No. 2005-067483

### SUMMARY

### Technical Problem

The driver of the vehicle which performs the trajectory control cannot predict change in direction of movement and travel speed of the vehicle by the trajectory control, so that the driver sometimes feel a sense of unease or a sense of discomfort. For example, in a situation in which a curvature of a travel path in front of the vehicle changes, the driver sometimes feels a sense of unease or a sense of discomfort wondering whether the vehicle travels along the travel path while appropriately changing the direction of movement and the travel speed.

In this regard, the conventional technology has a room for improvement in appropriately notifying the driver of the vehicle that the vehicle is executing the trajectory control. For example, this point is not taken into consideration in the technologies disclosed in Patent Literatures 1 and 2. Although the driver is visually notified of the state of the automatic steering control and the state of the automatic acceleration/deceleration in the technology disclosed in Patent Literature 3, it is significantly difficult to instantaneously and accurately comprehend preview contents regarding the change in the direction of movement of the vehicle from indication on a display.

Herein, there might be a method of allowing the driver of the vehicle to feel the change in the direction of movement and the travel speed of the vehicle by the trajectory control by lateral motion by steering control and longitudinal motion by acceleration/deceleration control in addition to visually notifying the driver of the vehicle that the vehicle is executing the trajectory control. However, during execution of the trajectory control, a situation in which the longitudinal motion by the acceleration/deceleration control intervenes in addition to the lateral motion by the steering control might be a situation in which steering is operated while an accelerator or a brake is operated, so that this is not preferable in consideration of stability of vehicle behavior.

In this manner, the conventional technology has a room for improvement in satisfying both appropriate notification of the execution of the trajectory control and the vehicle behavior stability.

The present invention is achieved in view of the above-described circumstances and an object thereof is to provide the driving assistance device and the driving assistance method capable of satisfying both the appropriate notification of the execution of the trajectory control and the vehicle behavior stability.

### Solution to Problem

A driving assistance device according to the present invention includes: a travelable region detecting device which detects a travelable region of a vehicle; a travel control device which executes trajectory control by at least one of steering control and acceleration/deceleration control based on a target trajectory generated such that the vehicle travels in the travelable region detected by the travelable region detecting device; and a control device which improves control accuracy of the steering control so as to improve a property of following the target trajectory at a time the acceleration/deceleration control is required as compared to a case in which the acceleration/deceleration control is not required at a time of execution of the trajectory control by the travel control device.

In the above-described driving assistance device, it is preferred that whether the acceleration/deceleration control is required is determined based on at least one of a turning radius of the target trajectory, a road gradient of a travel path, and a target vehicle speed.

In the driving assistance device, it is preferred that the control device controls to notify a driver of the vehicle by the acceleration/deceleration control that the trajectory control is being executed in a state in which the property of following the target trajectory is improved.

In the above-described driving assistance device, it is preferred that the control device calculates a target yaw rate based on the turning radius of the target trajectory, controls to make a ratio of braking force of a turning inner rear wheel to braking force of a turning inner front wheel of the vehicle larger as the target yaw rate is lower, and notifies the driver of the vehicle that the trajectory control is being executed by the acceleration/deceleration control.

A driving assistance method according to the present invention is executed in a driving assistance device including: a travelable region detecting device which detects a travelable region of a vehicle; a travel control device which executes trajectory control by at least one of steering control and acceleration/deceleration control based on a target trajectory generated such that the vehicle travels in the travelable region detected by the travelable region detecting device; and a control device, and the driving assistance method includes improving, by the control device, control accuracy of the steering control so as to improve a property of following the target trajectory at a time the acceleration/deceleration control is required as compared to a case in which the acceleration/deceleration control is not required at a time of execution of the trajectory control by the travel control device.

### Advantageous Effects of Invention

The driving assistance device and the driving assistance method according to the present invention have an effect of satisfying both the appropriate notification of the execution of the trajectory control and the vehicle behavior stability.

### BRIEF DESCRIPTION OF DRAWINGS

FIG. 1 is a schematic configuration diagram of a vehicle to which a driving assistance device according to an embodiment is applied.

FIG. 2 is a view illustrating an example of a situation in which a driver of the vehicle is notified that trajectory control is being executed in the embodiment.

FIG. 3 is a view illustrating an example of a situation in which the driver of the vehicle is notified that the trajectory control is being executed at the time of straight travel.

FIG. 4 is a view illustrating an example of a situation in which the driver of the vehicle is notified that the trajectory control is being executed at the time of entrance to a curve.

FIG. 5 is a map illustrating an example of a relationship between target deceleration and a curve radius.

FIG. 6 is a view illustrating another example of the situation in which the driver of the vehicle is notified that the trajectory control is being executed at the time of the entrance to the curve.

FIG. 7 is a map illustrating an example of a relationship between a target yaw rate and the curve radius.

FIG. 8 is a view illustrating an example of a situation in which the driver of the vehicle is notified that the trajectory control is being executed at the time of exit from the curve.

FIG. 9 is a flowchart illustrating an example of a procedure of the driving assistance device according to the embodiment.

### DESCRIPTION OF EMBODIMENTS

An embodiment according to the present invention is hereinafter described in detail with reference to the drawings. Meanwhile, the present invention is not limited by the embodiment. Components in the following embodiment include a component easily replaced by one skilled in the art or a substantially identical component.

### Embodiment

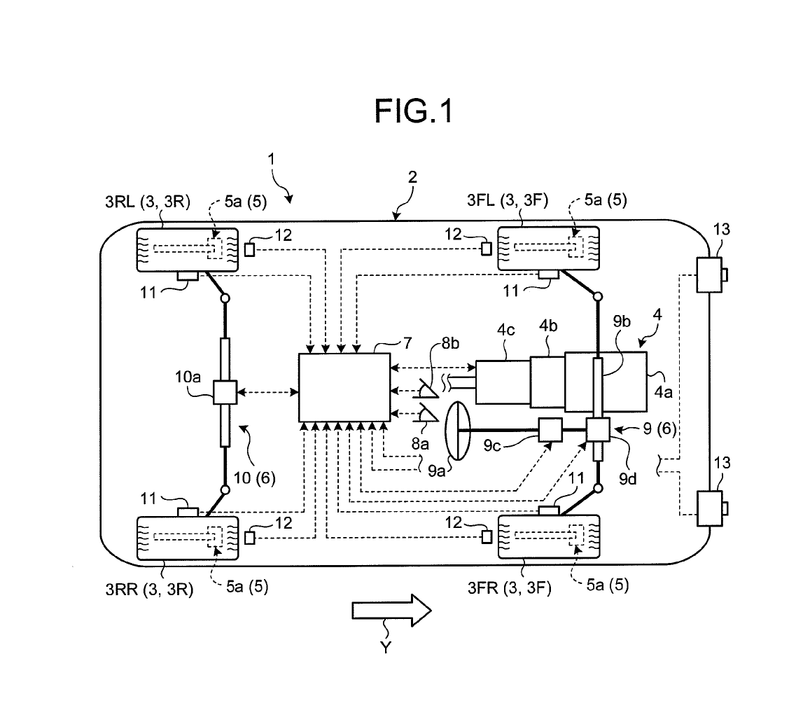

A configuration of a driving assistance device according to this embodiment is described with reference to FIGS. 1 to 8. FIG. 1 is a schematic configuration diagram of a vehicle 2 to which the driving assistance device according to the embodiment is applied.

A driving assistance device 1 of this embodiment is mounted on a 4-wheel steering vehicle 2 as illustrated in FIG. 1. Meanwhile, the vehicle 2 herein moves forward in a direction indicated by arrow Y in FIG. 1. The direction in which the vehicle 2 moves forward is a direction from a driver's seat on which a driver of the vehicle 2 sits toward a steering wheel. Right and left sides are defined based on the direction in which the vehicle 2 moves forward (direction indicated by arrow Y in FIG. 1). That is to say, “left” is intended to mean the left side as seen in the direction in which the vehicle 2 moves forward and “right” is intended to mean the right side as seen in the direction in which the vehicle 2 moves forward. As for front and rear sides of the vehicle 2, a side in the direction in which the vehicle 2 moves forward is the front side and a side in a direction in which the vehicle 2 moves rearward, that is to say, in the direction opposite to the direction in which the vehicle 2 moves forward is the rear side.

The vehicle 2 is provided with a left front wheel (wheel 3 on a left front side) 3FL, a right front wheel (wheel 3 on a right front side) 3FR, a left rear wheel (wheel 3 on a left rear side) 3RL, and a right rear wheel (wheel 3 on a right rear side) 3RR as wheels 3. Meanwhile, in the following description, when it is not especially required to individually describe the left front wheel 3FL, the right front wheel 3FR, the left rear wheel 3RL, and the right rear wheel 3RR, they are sometimes simply referred to as the “wheels 3”. In the following description, when it is not especially required to individually describe the left front wheel 3FL and the right front wheel 3FR, they are sometimes simply referred to as “front wheels 3F”. Similarly, in the following description, when it is not especially required to individually describe the left rear wheel 3RL and the right rear wheel 3RR, they are sometimes simply referred to as “rear wheels 3R”.

The driving assistance device 1 is equipped with a steering device 6 and the like as an actuator capable of steering the front wheel 3F and the rear wheel 3R of the vehicle 2. The driving assistance device 1 typically arbitrarily controls vehicle body slip angle attitude with respect to steering in the vehicle 2 provided with the steering device 6 being a 4-wheel steering mechanism formed of a front wheel steering device 9, a rear wheel steering device 10 and the like.

Specifically, the driving assistance device 1 is provided with a driving device 4, a braking device 5, the steering device 6, and an electronic control unit (ECU) 7 as a control device as illustrated in FIG. 1.

The driving device 4 forms a power train including a power source 4a, a torque converter 4b, a transmission 4c and the like in the vehicle 2 to realize rotary drive of the wheel 3 serving as a driving wheel. The power source 4a configured to generate rotary power which allows the vehicle 2 to travel is a power source for travel such as an internal-combustion engine (engine) and an electric motor (rotary machine). The driving device 4 transmits the power generated by the power source 4a from the power source 4a through the torque converter 4b, the transmission 4c and the like to the wheel 3 (for example, the left rear wheel 3RL and the right rear wheel 3RR as the driving wheels). The driving device 4 is electrically connected to the ECU 7 to be controlled by the ECU 7. In the vehicle 2, the driving device 4 generates the power (torque) according to operation of an accelerator pedal 8a (accelerator operation) by the driver and the power is transmitted to the wheel 3 to generate driving force on the wheel 3. In this embodiment, the driving device 4 serves as a part of a travel control device which executes trajectory control by acceleration control based on a target trajectory generated such that the vehicle 2 travels in a travelable region detected by a front part detecting device 13 to be described later.

The braking device 5 generates braking force on the wheel 3 in the vehicle 2. As the braking device 5, a braking unit 5a is provided on each wheel 3. Each braking unit 5a configured to apply the braking force by friction to each wheel 3 of the vehicle 2 is a hydraulic brake device, for example. Each braking unit 5a operates according to wheel cylinder pressure by brake oil supplied to a wheel cylinder to generate pressure braking force on the wheel 3. In the braking device 5, master cylinder pressure is applied to the brake oil by a master cylinder according to operation of a brake pedal 8b (brake operation) by the driver. In the braking device 5, pressure according to the master cylinder pressure or pressure adjusted by a hydraulic control device acts as the wheel cylinder pressure on each wheel cylinder. In each braking unit 5a, a brake pad supported by a caliper abuts a disk rotor to be pressed against the same by the wheel cylinder pressure, so that an abutment surface between the brake pad and the disk rotor becomes a frictional surface. Each braking unit 5a may apply the braking force by friction to the wheel 3 by predetermined rotational resistance force according to the wheel cylinder pressure acting on the disk rotor rotating together with the wheel 3 by the frictional force generated on the frictional surface. In this embodiment, the braking device 5 serves as a part of the travel control device which executes the trajectory control by deceleration control based on the target trajectory generated such that the vehicle 2 travels in the travelable region detected by the front part detecting device 13 to be described later.

The steering device 6 capable of steering the front wheel 3F and the rear wheel 3R of the vehicle 2 herein includes the front wheel steering device 9 and the rear wheel steering device 10. The front wheel steering device 9 capable of steering the front wheel 3F of the vehicle 2 steers the left front wheel 3FL and the right front wheel 3FR as steered wheels. The rear wheel steering device 10 capable of steering the rear wheel 3R of the vehicle 2 steers the left rear wheel 3RL and the right rear wheel 3RR as the steered wheels. In this embodiment, the steering device 6 serves as apart of the travel control device which executes the trajectory control by steering control based on the target trajectory generated such that the vehicle 2 travels in the travelable region detected by the front part detecting device 13 to be described later.

Meanwhile, in the following description, the above-described driving device 4, braking device 5, and steering device 6 are sometimes referred to as the travel control device. That is to say, the travel control device of this embodiment has a function of executing the trajectory control by at least one of the steering control and the acceleration/deceleration control based on the target trajectory generated such that the vehicle 2 travels in the travelable region detected by the front part detecting device 13 to be described later.

The front wheel steering device 9 is provided with a steering wheel (steering wheel) 9a as a steering member being a steering operator operated by the driver, and a turning angle applying mechanism 9b driven in accordance with steering operation of the steering wheel 9a to allow the front wheel 3F to turn. As the turning angle applying mechanism 9b, a so-called rack and pinion mechanism and the like provided with a rack gear and a pinion gear may be used, for example, but the mechanism is not limited thereto. Furthermore, the front wheel steering device 9 includes a variable gear ratio steering (VGRS) device 9c, a steering driver (booster) 9d for front wheel and the like arranged between the steering wheel 9a and the turning angle applying mechanism 9b. The VGRS device 9c is a variable gear ratio steering mechanism capable of changing a gear ratio of the steering wheel 9a. The front wheel steering device 9 may change a turning angle of the front wheel 3F (hereinafter, sometimes referred to as “front wheel turning angle”) with respect to a steering wheel steering angle (steering angle) being an operation amount of the steering wheel 9a according to a driving state of the vehicle 2 (for example, a vehicle speed being a travel speed of the vehicle 2) by the VGRS device 9c, for example. The steering driver (steering assist device) 9d is a so-called electric power assist steering (EPS) device which assists steering force applied to the steering wheel 9a by the driver by the power of the electric motor and the like (steering assist force). The front wheel steering device 9 is electrically connected to the ECU 7 and the VGRS device 9c, the steering driver 9d and the like are controlled by the ECU 7.

The rear wheel steering device 10 is a so-called active rear steering (ARS) device. The rear wheel steering device 10 is provided with a steering driver 10a for rear wheel driven by the power of the electric motor and the like to allow the rear wheel 3R to turn. The rear wheel steering device 10 may change a turning angle of the rear wheel 3R (hereinafter, sometimes referred to as “rear wheel turning angle”) with respect to the steering wheel steering angle according to the driving state (for example, the vehicle speed) of the vehicle 2 by the steering driver 10a, for example, as in the case of the front wheel steering device 9. The rear wheel steering device 10 is electrically connected to the ECU 7 and the steering driver 10a and the like is controlled by the ECU 7. The rear wheel steering device 10 steers the rear wheel 3R in the same phase as the turning angle of the front wheel 3F or in the phase opposite to this according to the driving state (for example, the vehicle speed and a turning state) of the vehicle 2 by the ECU 7, for example.

In the driving assistance device 1, the steering device 6 being the 4-wheel steering mechanism is formed of the front wheel steering device 9 and the rear wheel steering device 10 as described above and the left rear wheel 3RL and the right rear wheel 3RR as well as the left front wheel 3FL and the right front wheel 3FR become the steered wheels. The front wheel steering device 9 and the rear wheel steering device 10 may also change the turning angles of the front wheel 3F and the rear wheel 3R by control of the ECU 7 irrespective of the steering operation by the driver.

The steering device 6 also is the actuator capable of adjusting a vehicle body slip angle of the vehicle 2. Herein, the vehicle body slip angle is an angle between a center line in a longitudinal direction of a vehicle body of the vehicle 2 (vehicle body direction) and a direction of movement of the vehicle body of the vehicle 2 (speed vector), the angle of the center line in the longitudinal direction of the vehicle body of the vehicle 2 with respect to a turning tangential direction of the vehicle 2, for example. In a state in which the center line in the longitudinal direction of the vehicle body coincides with the direction of movement of the vehicle body, for example, the vehicle body slip angle is 0 [rad]. The vehicle body slip angle is determined according to the front wheel turning angle, the rear wheel turning angle and the like of the vehicle 2, for example. The steering device 6 may adjust the vehicle body slip angle of the vehicle 2 by adjusting the front wheel turning angle and the rear wheel turning angle.

The ECU 7 being the control device which controls drive of each unit of the vehicle 2 includes an electronic circuit a main body of which is a well-known microcomputer including a CPU, a ROM, a RAM, and an interface. To the ECU 7, various sensors and detectors are electrically connected, for example, and electric signals corresponding to detection results are input. The ECU 7 executes a stored control program based on various input signals input from the various sensors, detectors and the like and various maps, thereby outputting driving signals to respective units of the vehicle 2 such as the driving device 4, the braking device 5, the front wheel steering device 9, and the rear wheel steering device 10 to control the drive of them.

The driving assistance device 1 of this embodiment is provided with a wheel speed sensor 11, a wheel cylinder pressure sensor 12, the front part detecting device 13 and the like, for example, as the various sensors and detectors. A total of four wheel speed sensors 11 are provided for the left front wheel 3FL, the right front wheel 3FR, the left rear wheel 3RL, and the right rear wheel 3RR, respectively. Each wheel speed sensor 11 detects a wheel speed being a rotational speed of each of the left front wheel 3FL, the right front wheel 3FR, the left rear wheel 3RL, and the right rear wheel 3RR. The ECU 7 may calculate the vehicle speed being the travel speed of the vehicle 2 based on the wheel speed of each wheel 3 input from each wheel speed sensor 11. A total of four wheel cylinder pressure sensors 12 are provided for the braking units 5a of the left front wheel 3FL, the right front wheel 3FR, the left rear wheel 3RL, and the right rear wheel 3RR, respectively. Each wheel cylinder pressure sensor 12 detects the wheel cylinder pressure of each braking unit 5a of the left front wheel 3FL, the right front wheel 3FR, the left rear wheel 3RL, and the right rear wheel 3RR. The front part detecting device 13 detects a situation in front of the vehicle 2 in the direction of movement (direction in the forward movement direction Y). Millimeter wave radar, radar using a laser, infrared radiation and the like, close-range radar such as ultra wide band (UWB) radar, sonar using an audible acoustic wave or an ultrasonic wave, an image recognizing device which detects the situation in front of the vehicle 2 in the direction of movement by analyzing image data obtained by imaging an area in front of the vehicle 2 in the direction of travel by an imaging device such as a CCD camera and the like may be used, for example, as the front part detecting device 13. Meanwhile, one radar or one camera may be used as the front part detecting device 13. The front part detecting device 13 may detect at least one of presence of a peripheral object (obstacle, preceding vehicle and the like) in front of the vehicle 2 in the direction of movement, a relative physical amount indicating a relative positional relationship between the detected peripheral object and the vehicle 2, a shape of a road on which the vehicle 2 travels, a travel lane (lane) and the like, for example, as the situation in front of the vehicle 2 in the direction of movement. In this embodiment, the front part detecting device 13 serves as a travelable region detecting device which detects the travelable region of the vehicle 2. Herein, the travelable region is intended to mean a range in which the vehicle 2 may travel in consideration of the travel lane, a guardrail, the obstacle and the like, for example. In the following description, the front part detecting device 13 is sometimes referred to as the travelable region detecting device.

An electric signal corresponding to the steering wheel steering angle (steering angle) detected by a steering wheel steering angle sensor is input from the VGRS device 9c to the ECU 7. The steering wheel steering angle is a steering angle of the steering wheel 9a (rotational angle of the steering wheel 9a). An electric signal corresponding to the front wheel turning angle detected by a front wheel turning angle sensor is input from the steering driver 9d to the ECU 7. The front wheel turning angle is the turning angle of the front wheel 3F (rotational angle of the front wheel 3F). Similarly, an electric signal corresponding to the rear wheel turning angle detected by a rear wheel turning angle sensor is input from the steering driver 10a to the ECU 7. The rear wheel turning angle is the turning angle of the rear wheel 3R (rotational angle of the rear wheel 3R).

The ECU 7 controls the front wheel steering device 9 and the rear wheel steering device 10 to steer the front wheel 3F and the rear wheel 3R, respectively, according to a vehicle body slip angle property of the vehicle 2 set in advance, for example, thereby changing the front wheel turning angle and the rear wheel turning angle. The ECU 7 calculates a target yaw rate and a target vehicle body slip angle based on the steering wheel steering angle, the vehicle speed and the like, for example. The target yaw rate and the target vehicle body slip angle being a yaw rate and the vehicle body slip angle which are made targets at the time of the steering control of the front wheel steering device 9 and the rear wheel steering device 10 are set to values to stabilize behavior of the vehicle 2, for example. The ECU 7 calculates a control amount of the front wheel turning angle and a control amount of the rear wheel turning angle such that the calculated target yaw rate and target vehicle body slip angle may be realized. The ECU 7 performs inverse operation of the control amounts of the front wheel turning angle and the rear wheel turning angle from the target yaw rate and the target vehicle body slip angle by using a vehicle model of the vehicle 2 stored in a storage unit in advance, for example. The ECU 7 outputs a control instruction to the front wheel steering device 9 and the rear wheel steering device 10 based on the calculated control amounts of the front wheel turning angle and the rear wheel turning angle. The ECU 7 performs feedback-control of actual front wheel turning angle and rear wheel turning angle detected by the front wheel turning angle sensor of the steering driver 9d and the rear wheel turning angle sensor of the steering driver 10a and controls the front wheel steering device 9 and the rear wheel steering device 10 such that actual yaw rate and vehicle body slip angle converge to the target yaw rate and the target vehicle body slip angle, respectively. As a result, the vehicle 2 may travel with the front wheel 3F and the rear wheel 3R steered by the front wheel steering device 9 and the rear wheel steering device 10, respectively, according to a predetermined vehicle body slip angle property.

The ECU 7 may further perform automatic driving control to control the vehicle 2 to perform automatic driving. The ECU 7 may control the vehicle 2 based on a detection result by the front part detecting device 13 to execute the automatic driving control, for example. The automatic driving control is the trajectory control to generate the target trajectory based on the detection result by the front part detecting device 13 and control the driving device 4, the braking device 5, and the steering device 6 (front wheel steering device 9 and rear wheel steering device 10) as the travel control device based on the target trajectory, for example. The ECU 7 generates the target trajectory being a target travel trajectory of the vehicle 2 within the travelable region based on the presence of the peripheral object (obstacle) in front of the vehicle 2 in the direction of movement, the relative physical amount between the peripheral object and the vehicle 2, the shape of the road on which the vehicle 2 travels, the travel lane, the guardrail and the like detected by the front part detecting device 13. The ECU 7 generates the target trajectory of the vehicle 2 according to the travel trajectory for allowing the vehicle 2 being an own vehicle to travel within a current travel lane (lane keeping assist), the travel trajectory for avoiding the obstacle in front of the vehicle 2 in the direction of movement, the travel trajectory for allowing the vehicle 2 to travel while following the preceding vehicle and the like, for example. The ECU 7 controls the driving device 4, the braking device 5, the steering device 6 (front wheel steering device 9 and rear wheel steering device 10) as the travel control device such that the vehicle 2 moves in the direction of movement and with the attitude according to the generated target trajectory. In this case, the ECU 7 calculates the target yaw rate and the target vehicle body slip angle based on indices regarding the generated target trajectory (for example, a turning radius according to the target trajectory, a distance to the obstacle, a lateral target motion distance and the like) in addition to the above-described steering wheel steering angle and vehicle speed, for example. The ECU 7 controls the front wheel steering device 9 and the rear wheel steering device 10 according to the control amounts of the front wheel turning angle and the rear wheel turning angle based on the calculated target yaw rate and target vehicle body slip angle as in the above-described manner. As a result, the vehicle 2 may travel along the target trajectory with the front wheel 3F and the rear wheel 3R steered by the front wheel steering device 9 and the rear wheel steering device 10, respectively, according to the vehicle body slip angle property.

The ECU 7 may also perform the automatic driving control such as auto-cruise travel to automatically control the vehicle speed at a predetermined vehicle speed, automatic following travel to automatically follow the preceding vehicle with a constant inter-vehicular distance, automatic control of stop and start of the vehicle 2 according to light of traffic lights and a position of a stop line in front in the direction of movement and the like, for example. Meanwhile, the driving assistance device 1 may arbitrarily switch on/off the automatic driving control (trajectory control) according to an intention of the driver according to switching operation by the driver by means of a predetermined selector switch, for example.

Herein, the driver of the vehicle 2 which performs the trajectory control cannot predict change in the direction of movement and the travel speed of the vehicle 2 by the trajectory control, so that the driver sometimes feels a sense of unease or a sense of discomfort. Therefore, the driving assistance device 1 of this embodiment performs control to notify the driver of the vehicle 2 that the trajectory control is being executed by lateral motion by the steering control and longitudinal motion by the acceleration/deceleration control. According to this, the driving assistance device 1 of this embodiment may notify that the trajectory control is being executed by not only the lateral motion by the steering control but also the longitudinal motion by the acceleration/deceleration control, thereby realizing recognition matching the motion of the vehicle 2 and reducing a sense of unease or a sense of discomfort, which the driver of the vehicle 2 performing the trajectory control might feel.

In this embodiment, the control to notify by the steering control that the trajectory control is being executed includes, for example, control to apply steering wheel torque such that the steering wheel 9a grabbed by the driver of the vehicle 2 is moved in the direction of movement of the vehicle 2 according to the change in the direction of movement of the vehicle 2 by the trajectory control and the like. The control to notify by the acceleration/deceleration control that the trajectory control is being executed includes, for example, control to change a control amount of the acceleration/deceleration control such that the driver of the vehicle 2 may feel that the trajectory control is being executed according to the change in the direction of movement and the travel speed of the vehicle 2 by the trajectory control and the like.

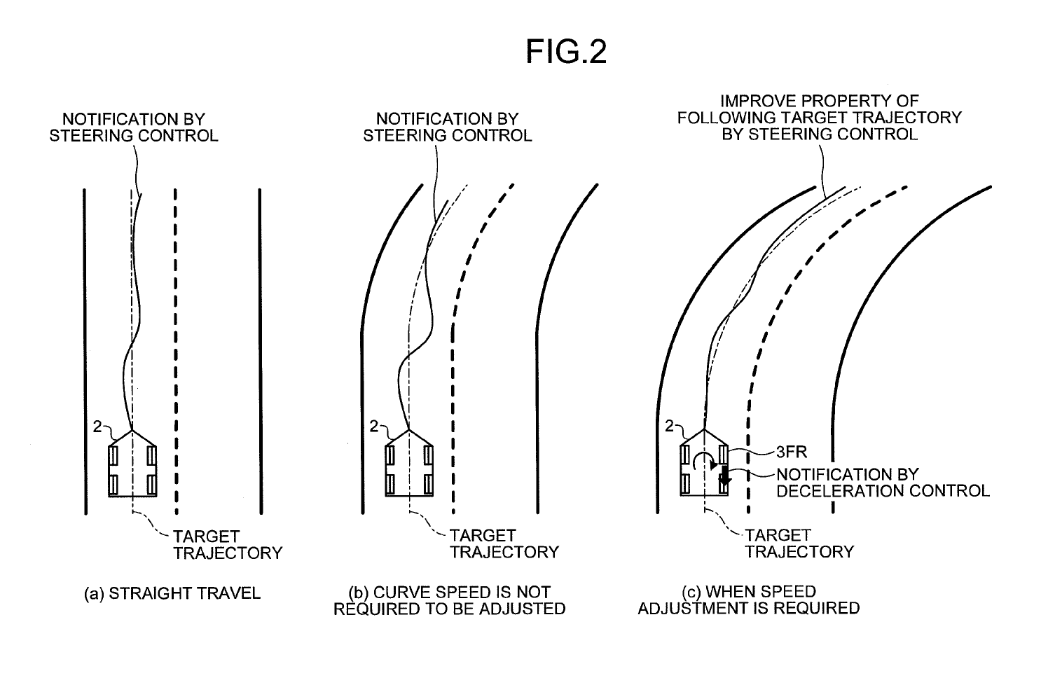

As an example, as illustrated in FIG. 2, the driving assistance device 1 notifies the driver of the vehicle 2 that the vehicle 2 is executing the trajectory control by the steering control or the deceleration control in the vehicle 2 which executes the trajectory control to realize a predetermined target trajectory. FIG. 2 is a view illustrating an example of a situation in which the driver of the vehicle 2 is notified that the trajectory control is being executed in this embodiment.

Herein, FIG. 2(a) illustrates a situation at the time of straight travel in which the target trajectory is set for the straight travel. In the situation illustrated in FIG. 2(a), the driving assistance device 1 turns to modify the vehicle 2 which slants by disturbance such as unevenness of a road surface and wind by the steering control such that the vehicle 2 follows the target trajectory set for the straight travel. That is to say, as illustrated in FIG. 2(a), at the time of the travel to follow the target trajectory set for the straight travel at a constant speed, the driving assistance device 1 notifies the driver of the vehicle 2 by the steering control of the change in the direction of movement of the vehicle 2 by the trajectory control.

FIG. 2(b) illustrates a situation in which the target trajectory is set along a gentle curve (that is to say, the curve with a large turning radius of the target trajectory) and a curve speed is not required to be adjusted. In a case of the gentle curve as illustrated in FIG. 2(b), the vehicle 2 may travel on the curve without adjusting the travel speed (adjusting such that the travel speed is decreased in FIG. 2(b)). In this case, the driving assistance device 1 performs the trajectory control such that the vehicle 2 follows the target trajectory set along the gentle curve by the steering control. That is to say, the driving assistance device 1 notifies the driver of the vehicle 2 by the steering control of the change in the direction of movement of the vehicle 2 by the trajectory control at the time of the travel to follow the target trajectory set along the gentle curve at a constant speed as illustrated in FIG. 2(b).

FIG. 2(c) illustrates a situation in which the target trajectory is set along a sharp curve (that is to say, the curve with a small turning radius of the target trajectory) and speed adjustment is required. In a case of the sharp curve as illustrated in FIG. 2(c), the vehicle 2 is required to adjust the travel speed (adjust to decrease the travel speed in FIG. 2(c)) and to perform the steering control to allow the vehicle 2 to follow the target trajectory set along the sharp curve. However, during execution of the trajectory control, it is considered that the driver of the vehicle 2 may realize better by feeling that the trajectory control is being executed when notified of this by one piece of information of the deceleration control rather than when notified of this by two pieces of information of the steering control and the deceleration control. Furthermore, during the execution of the trajectory control, a situation in which the longitudinal motion by the deceleration control intervenes in addition to the lateral motion by the steering control might be a situation in which steering is operated during the brake operation, so that this is considered to be not preferable in consideration of stability of the vehicle behavior.

Therefore, in this embodiment, in a case illustrated in FIG. 2(c), the driving assistance device 1 performs the trajectory control such that the vehicle 2 follows the target trajectory set along the sharp curve by the deceleration control in a state in which a property of following the target trajectory by the steering control is improved. Specifically, in FIG. 2(c), the driving assistance device 1 allows the vehicle 2 to turn right while adjusting the speed by applying the braking force to a turning inner front wheel (right front wheel 3FR in FIG. 2(c)) by controlling the braking device 5 such that the vehicle 2 follows the target trajectory set along the sharp curve in the state in which the property of following the target trajectory by the steering control is improved.

In this embodiment, the property of following the target trajectory by the steering control is determined by control accuracy of the steering control at the time of the trajectory control set in advance. For example, the control accuracy of the steering control is set in advance to a value such that amplitude falls within a predetermined range at frequencies in a predetermined range. The control accuracy is improved when the amplitude falls within a range smaller than the above-described predetermined range at the frequencies in the above-described predetermined range. Supposing that the amplitude within the predetermined range set in advance is the amplitude within a first predetermined range, the driving assistance device 1 of this embodiment sets the amplitude within the first predetermined range to a little smaller value, for example, the value within a second predetermined range smaller than the first predetermined range. In this manner, the driving assistance device 1 may improve the property of following the target trajectory by controlling the EPS and the VGRS by setting the amplitude to the value within the second predetermined range smaller than the first predetermined range. Meanwhile, a relationship between the frequency and the amplitude is preferably constant in order to notify the driver of the execution of the trajectory control. Herein, the control accuracy of the steering control is not limited to an example in which the value of the amplitude is set to be smaller than a normal value and it is also possible to improve the control accuracy of the steering control by setting a value of the yaw rate allowable at the time of the trajectory control to be smaller than the normal value, for example. In addition, it is also possible to improve the control accuracy of the steering control by setting the turning angle of the steered wheel with respect to the steering wheel steering angle to be smaller than the normal value, for example.

In this manner, during the execution of the trajectory control by the travel control device, when the deceleration control is required as illustrated in FIG. 2(c), the driving assistance device 1 improves the control accuracy of the steering control so as to improve the property of following the target trajectory as compared to a case in which the deceleration control is not required. The control device of the driving assistance device 1 controls to notify that the trajectory control is being executed by the deceleration control in the state in which the property of following the target trajectory is improved. Necessity of the deceleration control is determined based on at least one of the turning radius of the target trajectory, a road gradient of a travel path, and the target vehicle speed. According to this, the vehicle 2 is put into the state in which the property of following the target trajectory is improved, so that the slant of the vehicle 2 is reduced and it becomes difficult to notify that the trajectory control is being executed by means of the lateral motion by the steering control. As a result, it becomes easy to notify that the trajectory control is being executed by the longitudinal motion by the deceleration control. Furthermore, in this case, the vehicle behavior is controlled mainly by the deceleration control, so that the situation in which the steering is operated during the brake operation does not occur and the stability of the vehicle behavior is improved.

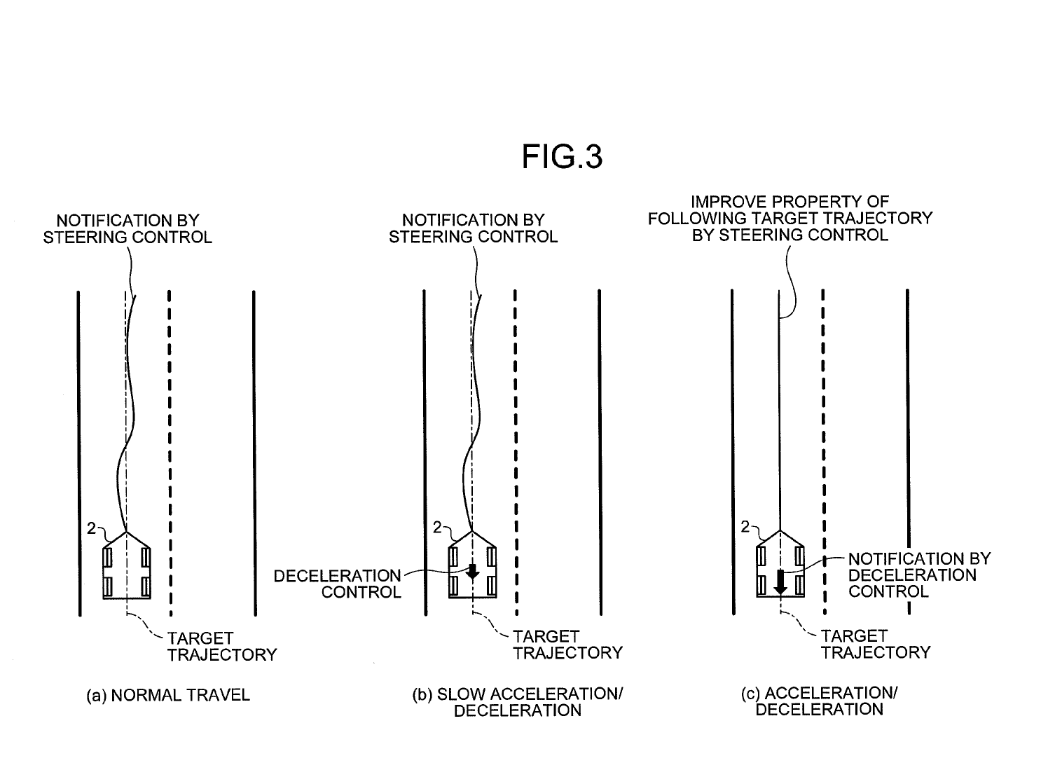

Hereinafter, various situations to notify the driver of the vehicle 2 that the trajectory control is being executed are described in detail as an example with reference to FIGS. 3 to 8.

As illustrated in FIG. 3, in a situation in which the target trajectory is set for the straight travel also, the driving assistance device 1 changes a content of the control to notify the driver of the vehicle 2 that the trajectory control is being executed according to a degree of change in the travel speed by the trajectory control. FIG. 3 is a view illustrating an example of a situation in which the driver of the vehicle 2 is notified that the trajectory control is being executed at the time of the straight travel.

FIG. 3(a) illustrates a situation at the time of normal travel in which the target trajectory is set for the straight travel and the target speed is set to maintain a constant speed. In the situation illustrated in FIG. 3(a), the driving assistance device 1 turns to modify the vehicle 2 which slants by the disturbance such as the unevenness of the road surface and the wind by the steering control such that the vehicle 2 follows the target trajectory set for the straight travel. That is to say, the driving assistance device 1 notifies the driver of the vehicle 2 by the steering control of the change in the direction of movement of the vehicle 2 by the trajectory control at the time of the travel to follow the target trajectory set for the straight travel at the constant speed as illustrated in FIG. 3(a).

FIG. 3(b) illustrates a situation at the time of slow deceleration travel in which the target trajectory is set for the straight travel and the target speed is set so as to slowly decelerate. In a case of slowly decelerating as illustrated in FIG. 3(b) (for example, when the road gradient is gentle or when the inter-vehicular distance from the vehicle in front is relatively long), the control amount of the deceleration control of the vehicle 2 is relatively small. In this case, it is considered that the longitudinal motion of the deceleration control has difficulty in notifying the driver of the vehicle 2 by feeling that the trajectory control is being executed.

Therefore, the driving assistance device 1 of this embodiment performs the trajectory control such that the vehicle 2 follows the target trajectory set for the straight travel by the steering control when the degree of change in the travel speed by the trajectory control is small. That is to say, the driving assistance device 1 notifies the driver of the vehicle 2 by the steering control of the change in the direction of movement of the vehicle 2 by the trajectory control at the time of the travel to follow the target trajectory set for the straight travel at the target speed set so as to slowly decelerate as illustrated in FIG. 3 (b). In general, at the time of the straight travel, when there is no tendency of lane departure, the driver of the vehicle 2 often does not mind whether the trajectory control is being executed, so that the driver is notified of an executing state of the trajectory control by change in steering angle or torque by the steering control in this embodiment.

Meanwhile, although the slow deceleration travel is described as an example in FIG. 3 (b), the same basically applies to a situation at the time of slow acceleration travel in which the target trajectory is set for the straight travel and the target speed is set so as to slowly accelerate. In this case, at the time of the travel to follow the target trajectory set for the straight travel at the target speed set so as to slowly accelerate, the driving assistance device 1 notifies the driver of the vehicle 2 by the steering control of the change in the direction of movement of the vehicle 2 by the trajectory control.

FIG. 3(c) illustrates a situation at the time of deceleration travel in which the target trajectory is set for the straight travel and the target speed is set so as to decelerate the vehicle 2. In a case of significant deceleration as illustrated in FIG. 3(c) (for example, when the road gradient is sharp to a certain degree or when the inter-vehicular distance from the vehicle in front is relatively short), the control amount of the deceleration control of the vehicle 2 is relatively large. In this case, longitudinal G not lower than a predetermined threshold set such that the driver may feel the same is applied to the driver of the vehicle 2 by the deceleration control, so that it is considered that the driver of the vehicle 2 may feel that the trajectory control is being executed by the longitudinal motion of the deceleration control.

Therefore, the driving assistance device 1 of this embodiment performs the trajectory control such that the vehicle 2 follows the target trajectory set for the straight travel by the deceleration control in the state in which the property of following the target trajectory by the steering control is improved when the degree of change in the travel speed by the trajectory control is high. That is to say, the driving assistance device 1 notifies the driver of the vehicle 2 by the deceleration control of the change in the travel speed of the vehicle 2 by the trajectory control at the time of the travel to follow the target trajectory set for the straight travel at the target speed set so as to decelerate as illustrated in FIG. 3(c).

Meanwhile, although the deceleration travel is described as an example in FIG. 3(c), the same basically applies to a situation at the time of acceleration travel in which the target trajectory is set for the straight travel and the target speed is set so as to accelerate. In this case, the driving assistance device 1 notifies the driver of the vehicle 2 by the acceleration control of the change in the travel speed of the vehicle 2 by the trajectory control at the time of the travel to follow the target trajectory set for the straight travel at the target speed set so as to accelerate.

In this manner, according to this embodiment, in a region with acceleration/deceleration which the driver of the vehicle 2 might feel, it is more natural to notify that the trajectory control is being executed by the longitudinal motion of the acceleration/deceleration control rather than to notify the same by the lateral motion of the steering control, and a sense of discomfort is reduced. Since the property of following the target trajectory by the steering control is improved, an effect of disturbance of vehicle motion by the steering is also small. However, when the acceleration/deceleration is low, there is a case in which the driver of the vehicle 2 cannot feel the same, so that the steering device 6 notifies that the trajectory control is being performed.

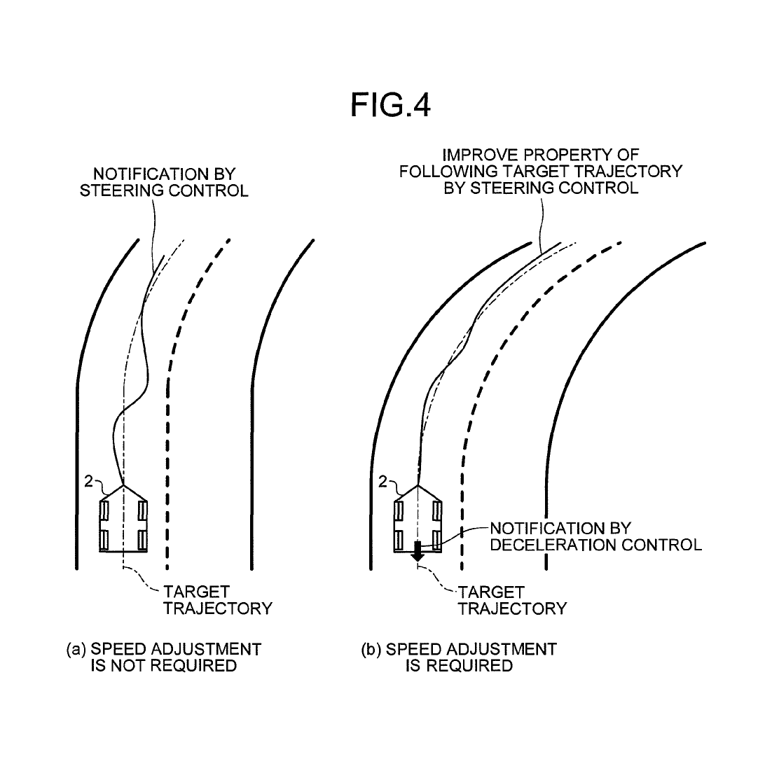

As illustrated in FIG. 4, in a situation in which the target trajectory is set for the travel along a curve at the time of entrance to the curve, the driving assistance device 1 changes the content of the control to notify the driver of the vehicle 2 that the trajectory control is being executed according to the turning radius of the target trajectory. FIG. 4 is a view illustrating an example of a situation of notifying the driver of the vehicle 2 that the trajectory control is being executed at the time of the entrance to the curve.

Herein, FIG. 4(a) illustrates a situation in which the target trajectory is set along the gentle curve (that is to say, the curve with the large turning radius of the target trajectory) and the speed is not required to be adjusted. In a case of the gentle curve as illustrated in FIG. 4(a), the vehicle 2 may travel on the curve without adjusting the travel speed (adjusting to decrease the travel speed in FIG. 4(a)). In this case, the driving assistance device 1 performs the trajectory control such that the vehicle 2 follows the target trajectory set along the gentle curve by the steering control. That is to say, the driving assistance device 1 notifies the driver of the vehicle 2 by the steering control of the change in the direction of movement of the vehicle 2 by the trajectory control at the time of the travel to follow the target trajectory set along the gentle curve at a constant speed as illustrated in FIG. 4(a).

The trajectory control is the control to trace (follow) the target trajectory, so that it is considered that a sense of discomfort felt by the driver of the vehicle 2 is smaller when the driver is notified that the trajectory control is being executed by the steering control. However, in a situation illustrated in FIG. 4(b) below, the travel speed is too high to travel on the sharp curve, so that there might be a case in which the vehicle cannot turn enough by the steering control of the trajectory control.

FIG. 4(b) illustrates the situation in which the target trajectory is set along the sharp curve (that is to say, the curve with the small turning radius of the target trajectory) and the speed adjustment is required. In a case of the sharp curve as illustrated in FIG. 4(b), the vehicle 2 is required to adjust the travel speed (adjust to decrease the travel speed in FIG. 4(b)). In this case, the driving assistance device 1 performs the trajectory control such that the vehicle 2 follows the target trajectory set along the sharp curve while adjusting the travel speed of the vehicle 2 by the deceleration control in the state in which the property of following the target trajectory by the steering control is improved. The travel speed of the vehicle 2 is decreased by the deceleration control before the entrance to the curve.

In this manner, the driving assistance device 1 of this embodiment notifies the driver of the vehicle 2 mainly by the steering control that the trajectory control is being executed when the vehicle may pass the curve at lateral acceleration not higher than a predetermined threshold without the speed adjustment (for example, the situation as illustrated in FIG. 4(a)) at the time of the entrance to the curve. In contrast, the driving assistance device 1 of this embodiment notifies that the vehicle 2 is in the state in which the deceleration is required (for example, in the case in FIG. 4 (b), there is the sharp curve in front, so that the deceleration is required) by the deceleration control when the speed adjustment is required (for example, when the deceleration is required as illustrated in FIG. 4(b)) at the time of the entrance to the curve. According to this, the driver of the vehicle 2 may realize that there is the curve in front of the vehicle 2 by the longitudinal motion by the deceleration control. Furthermore, the driver of the vehicle 2 may realize that the steering by the driver is also required when the deceleration by the trajectory control is not sufficient.

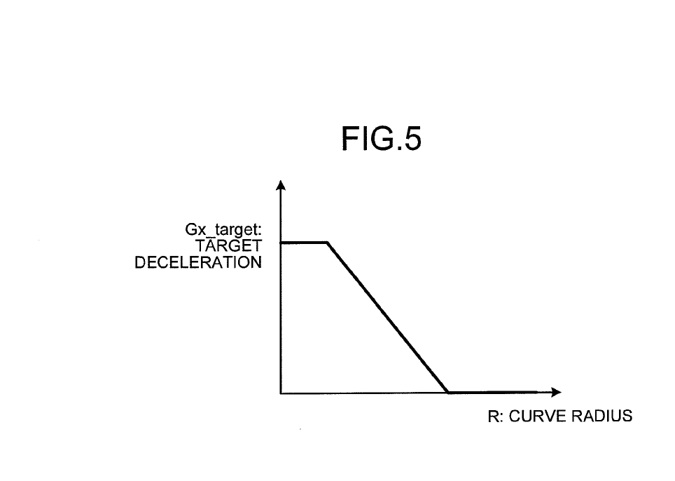

Herein, the driving assistance device 1 may change the content of the control to notify the driver of the vehicle 2 that the trajectory control is being executed according to target deceleration calculated according to the turning radius of the target trajectory in a situation in which the target trajectory is set for the travel along the curve at the time of the entrance to the curve. In this case, the driving assistance device 1 may calculate target deceleration (Gx_target) according to a curve radius (R) by using a map as illustrated in FIG. 5, for example. FIG. 5 illustrates the map illustrating an example of a relationship between the target deceleration and the curve radius. In FIG. 5, a value of the target deceleration (Gx_target) linearly decreases as a value of the curve radius (R) becomes larger. In addition, the driving assistance device 1 may calculate the target deceleration (Gx_target) according to the curve radius (R) according to a predetermined equation “Gx_target=(V−√(Gy_r_limit×R))/TL”, for example. Herein, in the above-described equation, “Gx_target” represents the target deceleration, “V” represents the vehicle speed, “Gy_r_limit” represents the lateral acceleration threshold, “R” represents the curve radius, and “TL” represents forward gazing time.

According to this, the driving assistance device 1 may notify the driver of a state of the curve in front by decelerating more as the curve radius is smaller when it is required to adjust the speed as illustrated in FIG. 4(b) at the time of the entrance to the curve. In this manner, the driving assistance device 1 may provide the deceleration according to the curve radius of the target trajectory in front at the time of the entrance to the curve, so that the driver of the vehicle 2 may realize that the curve in front is the sharp curve with the small radius when the deceleration is high, for example.

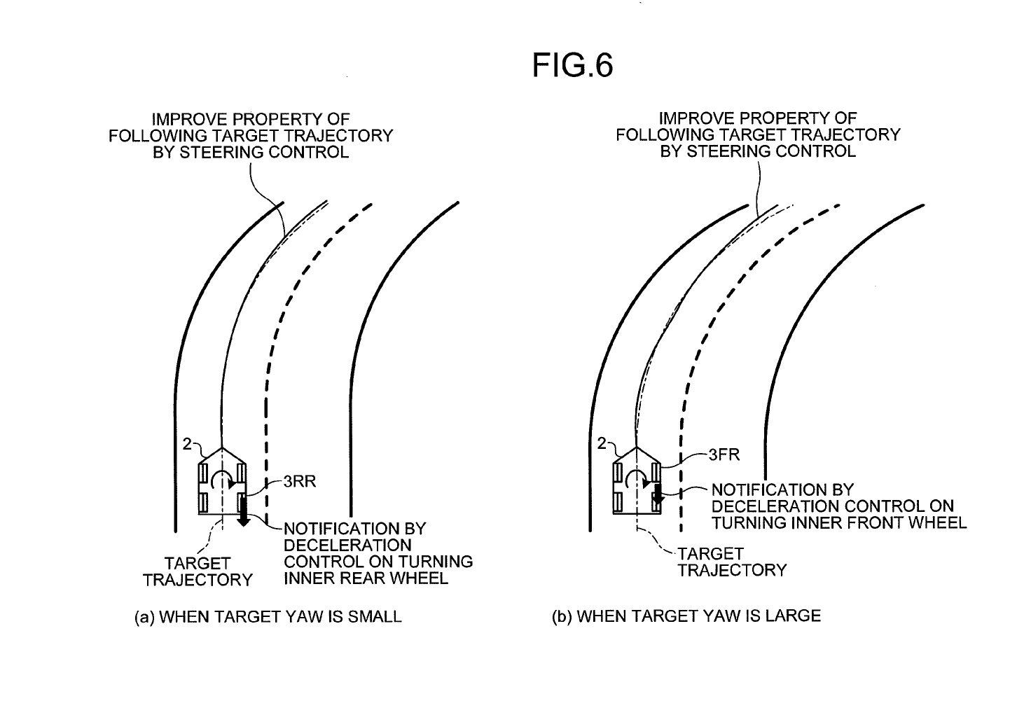

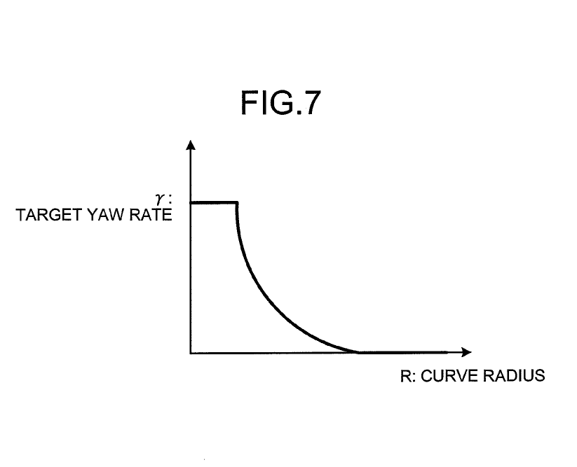

As illustrated in FIG. 6, the driving assistance device 1 may change the content of the control to notify the driver of the vehicle 2 that the trajectory control is being executed according to the target yaw rate determined according to the turning radius of the target trajectory in the situation in which the target trajectory is set for the travel along the curve at the time of the entrance to the curve. FIG. 6 is a view illustrating another example of the situation in which the driver of the vehicle is notified that the trajectory control is being executed at the time of the entrance to the curve. In this case, the driving assistance device 1 may calculate a target yaw rate (γ) according to the curve radius (R) by using a map as illustrated in FIG. 7, for example. FIG. 7 illustrates the map illustrating an example of a relationship between the target yaw rate and the curve radius. In FIG. 7, a value of the target yaw rate (γ) decreases in a secondary curve shape as the value of the curve radius (R) becomes larger. In addition, the driving assistance device 1 may calculate the target yaw rate (γ) according to the curve radius (R) according to a predetermined equation “γ=V/R”, for example. Herein, in the above-described equation, “γ” represents the target yaw rate, “V” represents the vehicle speed, and “R” represents the curve radius.

Herein, FIG. 6(a) illustrates a situation in which the target trajectory is set along the gentle curve (that is to say, the curve with the large turning radius of the target trajectory) and the target yaw rate is low. When the target yaw rate is low as illustrated in FIG. 6(a), the driving assistance device 1 allows the vehicle 2 to turn right while adjusting the speed by applying braking force to a turning inner rear wheel (right rear wheel 3RR in FIG. 6(a)) by controlling the braking device 5 such that the vehicle 2 follows the target trajectory set along the gentle curve in the state in which the property of following the target trajectory by the steering control is improved. That is to say, the driving assistance device 1 notifies the driver of the vehicle 2 by the deceleration control on the turning inner rear wheel of the change in the direction of movement and the travel speed of the vehicle 2 by the trajectory control when the target yaw rate is low as illustrated in FIG. 6(a).

FIG. 6(b) illustrates a situation in which the target trajectory is set along the sharp curve (that is to say, the curve with the small turning radius of the target trajectory) and the target yaw rate is high. When the target yaw rate is high as illustrated in FIG. 6(b), the driving assistance device 1 allows the vehicle 2 to turn right while adjusting the speed by applying the braking force to a turning inner front wheel (right front wheel 3FR in FIG. 6(b)) by controlling the braking device 5 such that the vehicle 2 follows the target trajectory set along the sharp curve in the state in which the property of following the target trajectory by the steering control is improved. That is to say, the driving assistance device 1 notifies the driver of the vehicle 2 by the deceleration control on the turning inner front wheel of the change in the direction of movement and the travel speed of the vehicle 2 by the trajectory control when the target yaw rate is high as illustrated in FIG. 6(b).

In this manner, the driving assistance device 1 calculates the target yaw rate based on the turning radius of the target trajectory and controls to make a ratio of the braking force of the turning inner rear wheel to the braking force of the turning inner front wheel of the vehicle 2 larger as the target yaw rate is lower. That is to say, the driving assistance device 1 changes the wheel to which negative torque is applied according to a target value of yaw motion. According to this, the driving assistance device 1 may decrease change in attitude by decelerating by the turning inner rear wheel when the target yaw motion is small and may create the change in attitude by decelerating by the turning inner front wheel when the target yaw motion is large, thereby reducing a sense of discomfort felt by the driver.

The driving assistance device 1 may generate the yaw motion together with the deceleration by using lateral difference in the braking force applied by the braking device 5 which executes the deceleration control and notify the driver of the same when it is required to adjust the speed as illustrated in FIGS. 6(a) and (b) at the time of the entrance to the curve. Herein, the trajectory control is the control to trace (follow) the target trajectory, so that a sense of discomfort felt by the driver of the vehicle 2 is considered to be smaller when the driver is notified that the trajectory control is being executed by the steering control. However, when there is the acceleration/deceleration, it is also possible to generate the yaw motion by using the lateral difference by the acceleration/deceleration, so that it is possible to notify the driver of the vehicle 2 of a state of trajectory tracing without using the steering control.

Furthermore, the driving assistance device 1 may notify the driver of the state of the curve in front by increasing the yaw motion to be generated as the curve radius is smaller when it is required to adjust the speed as illustrated in FIGS. 6(a) and (b) at the time of the entrance to the curve. In this manner, the driving assistance device 1 may generate the yaw motion according to the curve radius of the target trajectory in front at the time of the entrance to the curve, so that the driver of the vehicle 2 may realize that the curve in front is the sharp curve with the small radius when the yaw motion is large, for example.

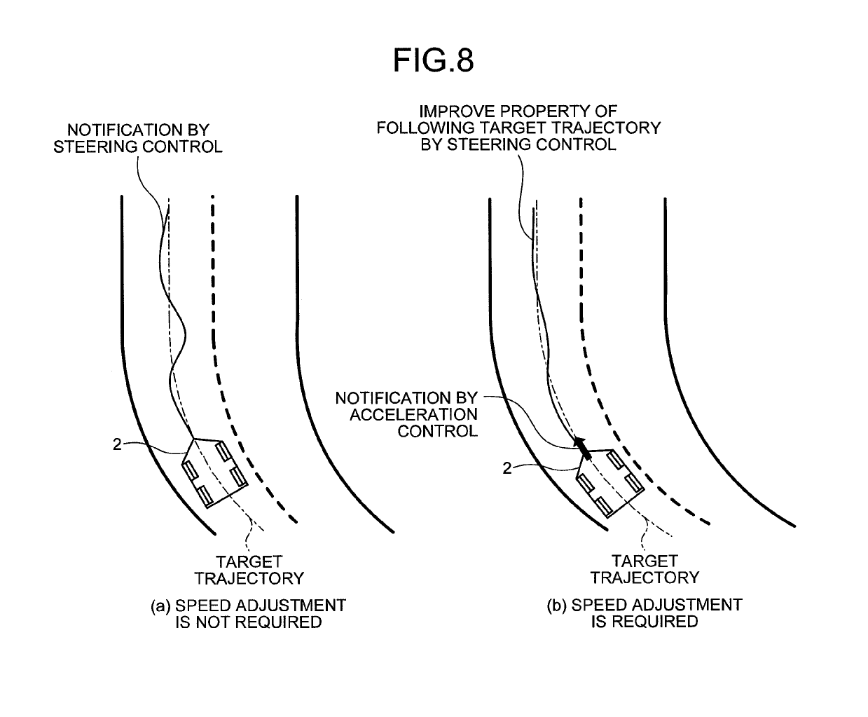

As illustrated in FIG. 8, the driving assistance device 1 changes the content of the control to notify the driver of the vehicle 2 that the trajectory control is being executed according to the turning radius of the target trajectory in a situation in which the target trajectory is set for the travel from the curve along a straight road at the time of exit from the curve. FIG. 8 is a view illustrating an example of a situation in which the driver of the vehicle 2 is notified that the trajectory control is being executed at the time of the exit from the curve.

Herein, FIG. 8(a) illustrates a situation in which the target trajectory is set from the gentle curve (that is to say, the curve with the large turning radius of the target trajectory) along the straight road and the speed is not required to be adjusted. When the vehicle 2 returns from the gentle curve to the straight road as illustrated in FIG. 8(a), this travels on the curve without adjusting the travel speed before entering the curve, so that it is not required to adjust the travel speed when returning to the straight road (adjust so as to increase the travel speed in FIG. 8(a)). In this case, the driving assistance device 1 performs the trajectory control such that the vehicle 2 follows the target trajectory set from the gentle curve along the straight road by the steering control. That is to say, the driving assistance device 1 notifies the driver of the vehicle 2 by the steering control of the change in the direction of movement of the vehicle 2 by the trajectory control at the time of the travel to follow the target trajectory set from the gentle curve along the straight road at a constant speed as illustrated in FIG. 8(a).

FIG. 8(b) illustrates a situation in which the target trajectory set from the sharp curve (that is to say, the curve with the small turning radius of the target trajectory) along the straight road and the speed is required to be adjusted. When the vehicle 2 returns from the sharp curve to the straight road as illustrated in FIG. 8(b), this travels on the curve after adjusting the travel speed before entering the curve, so that it is required to adjust the travel speed when returning to the straight road (adjust so as to increase the travel speed in FIG. 8(b)). In this case, the driving assistance device 1 performs the trajectory control such that the vehicle 2 follows the target trajectory set from the sharp curve along the straight road while adjusting the travel speed of the vehicle 2 by the acceleration control in the state in which the property of following the target trajectory by the steering control is improved. The travel speed of the vehicle 2 is increased by the acceleration control before the exit from the curve. Herein, the trajectory control is the control to trace (follow) the target trajectory, so that a sense of discomfort felt by the driver of the vehicle 2 is considered to be smaller when the driver is notified that the trajectory control is being executed by the steering control. However, when returning to the straight road, it is possible to reduce a sense of discomfort felt by the driver of the vehicle 2 by notifying by the acceleration control because there is no unsteady state by the steering control.

In this manner, the driving assistance device 1 of this embodiment notifies the driver of the vehicle 2 that the trajectory control is being executed mainly by the steering control when the target vehicle speed may be realized without the speed adjustment at the time of the exit from the curve (for example, the situation as illustrated in FIG. 8(a)). On the other hand, the driving assistance device 1 of this embodiment notifies that the vehicle 2 is in a state of requiring the acceleration (for example, in the case in FIG. 8(b), there is the straight road after the sharp curve ends and it is decelerated at the time of the entrance to the curve, so that the acceleration is required for realizing the target vehicle speed) by the acceleration control when the speed adjustment is required for realizing the target vehicle speed at the time of the exit from the curve (for example, when the acceleration is required as illustrated in FIG. 8(b)). According to this, the driver of the vehicle 2 may realize that there is the straight road after the curve of the vehicle 2 ends by the longitudinal motion by the acceleration control. Furthermore, the driver of the vehicle 2 may realize that the steering by the driver is also required when the acceleration by the trajectory control is not sufficient.

Herein, the driving assistance device 1 may change the content of the control to notify the driver of the vehicle 2 that the trajectory control is being executed according to the target acceleration calculated according to the turning radius of the target trajectory in the situation in which the target trajectory is set for the travel from the curve along the straight road at the time of the exit from the curve. The driving assistance device 1 may calculate the target acceleration by using a predetermined map and a predetermined equation. According to this, when the speed adjustment is required as illustrated in FIG. 8(b) at the time of the exit from the curve, the driving assistance device 1 may notify the driver of an ending state of the curve by applying larger acceleration as the end of the target trajectory with the small turning radius comes closer (that is to say, the turning radius of the target trajectory changes from a small value to a large value). In this manner, the driving assistance device 1 may provide the acceleration according to the turning radius of the target trajectory in front at the time of the exit from the curve, so that the driver of the vehicle 2 may realize that the end of the curve is closer and a long straight road will continue after the curve ends when the acceleration is large, for example.

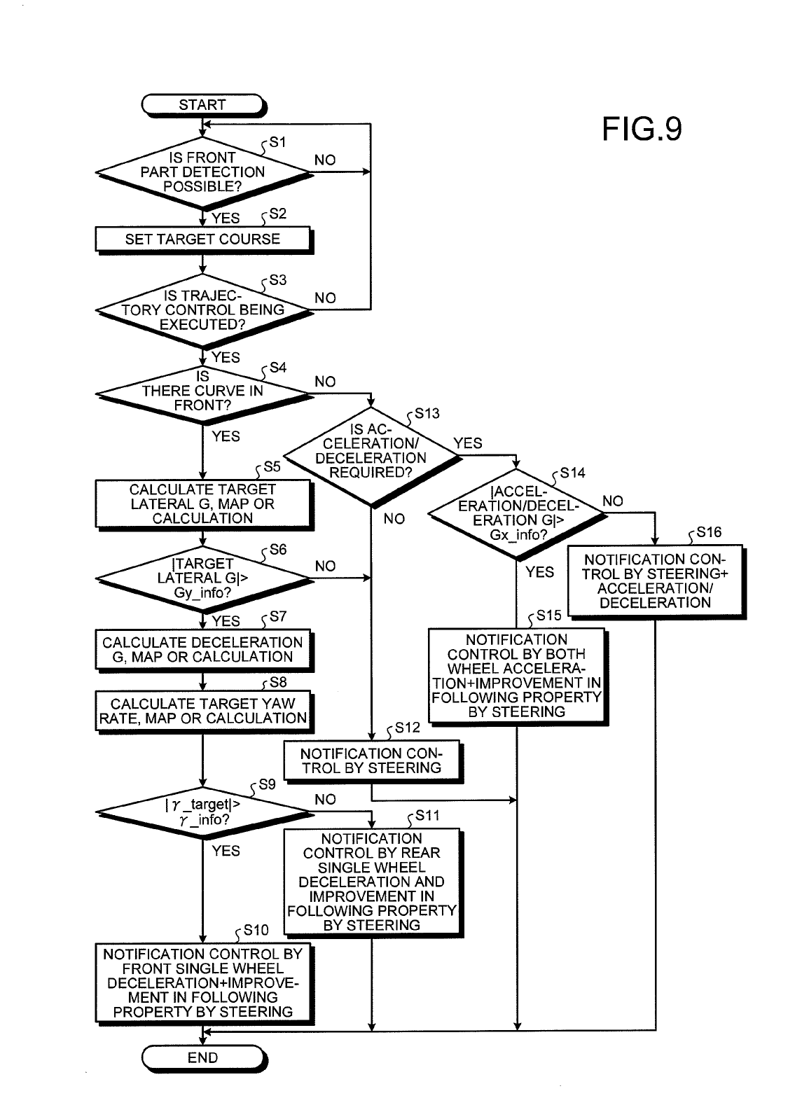

Subsequently, an example of a procedure executed by the driving assistance device 1 configured as described above is described with reference to FIG. 9. FIG. 9 is a flowchart illustrating an example of the procedure of the driving assistance device according to the embodiment. The following procedure is repeatedly executed by the ECU 7 as the control device of the driving assistance device 1.

As illustrated in FIG. 9, the driving assistance device 1 determines whether the vehicle 2 may detect a front part by the control of the travelable region detecting device (step S1). In this embodiment, the travelable region detecting device detects the travelable region of the vehicle 2. The travelable region is intended to mean the range in which the vehicle 2 may travel in consideration of the travel lane, the guardrail, the obstacle and the like, for example.

At step S1, when it is determined that the front part may be detected (Yes at step S1), that is to say, when the travelable region detecting device detects the travelable region, the procedure shifts to a process at step S2. On the other hand, when it is not determined that the front part may be detected at step S1 (No at step S1), that is to say, when the travelable region detecting device does not detect the travelable region, the procedure returns to the process at step S1.

The driving assistance device 1 sets a target course of the vehicle 2 corresponding to the target trajectory by generating the target trajectory based on the travelable region detected by the travelable region detecting device at step S1 (step S2). At step S2, the driving assistance device 1 generates the target trajectory being the target travel trajectory of the vehicle 2 within the travelable region based on the presence of the peripheral object (obstacle) in front of the vehicle 2 in the direction of movement, the relative physical amount between the peripheral object and the vehicle 2, the shape of the road on which the vehicle 2 travels, the travel lane, the guardrail and the like detected by the travelable region detecting device.

The driving assistance device 1 determines whether the vehicle 2 is performing the trajectory control (automatic driving control) by the control of the travel control device or whether it is in a state in which the trajectory control may be executed (step S3). In this embodiment, it is determined whether the trajectory control is being executed based on an on/off-state of a predetermined selector switch, for example.

When it is determined that the trajectory control is being executed or that it is in the state in which the trajectory control may be executed at step S3 (Yes at step S3), for example, when it is determined that the predetermined selector switch is in an on-state, the procedure shifts to a process at step S4. On the other hand, when it is determined that the trajectory control is not being executed or that it is in a state in which the trajectory control cannot be executed at step S3 (No at step S3), for example, when it is determined that the predetermined selector switch is in an off-state, the procedure returns to the process at step S1.

The driving assistance device 1 determines whether there is the curve in front of the vehicle 2 based on a detection result regarding a state in front of the vehicle 2 detected by the travelable region detecting device (step S4). At step S4, the driving assistance device 1 determines whether there is the curve in front of the vehicle 2 based on a curvature of the target trajectory generated based on the detection result detected by the travelable region detecting device. For example, the driving assistance device 1 determines that there is the curve when there is the curvature in the target trajectory corresponding to a predetermined distance in front of the vehicle 2, and on the other hand, determines that there is no curve and the road is straight when there is no curvature in the target trajectory corresponding to the predetermined distance in front of the vehicle 2. Meanwhile, at step S4, the driving assistance device 1 may determine whether there is the curve in front of the vehicle 2 based on a current position of the vehicle 2 and road map information by using a navigation device not illustrated.

At step S4, when it is determined that there is the curve in front of the vehicle 2 (Yes at step S4), the procedure shifts to a process at step S5. On the other hand, when it is determined that there is no curve in front of the vehicle 2 (No at step S4), the procedure shifts to a process at step S13.

When there is the curve in front of the vehicle 2 (Yes at step S4), the driving assistance device 1 calculates target lateral G when the vehicle 2 travels on the curve based on the curvature of the target trajectory in front (that is to say, the turning radius of the target trajectory) (step S5). At step S5, the driving assistance device 1 calculates the target lateral G by using a predetermined map and a predetermined equation, for example. At that time, the driving assistance device 1 may calculate the target lateral G in consideration of the road gradient of the travel path corresponding to the target trajectory in front.

The driving assistance device 1 determines whether magnitude of the target lateral G calculated at step S5 is higher than a predetermined threshold (step S6). At step S6, the driving assistance device 1 determines according to a determining equation “|target lateral G|>Gy_info”. In this determining equation, “|target lateral G|” represents an absolute value indicating the magnitude of the target lateral G and “Gy_info” represents the threshold of the lateral G serving as a determination reference for determining whether the vehicle 2 may travel on a target curve while maintaining the travel speed thereof.

At step S6, when it is determined that the magnitude of the target lateral G is higher than the predetermined threshold (Yes at step S6), the procedure shifts to a process at step S7. On the other hand, when it is determined that the magnitude of the target lateral G is lower than the predetermined threshold (No at step S6), the procedure shifts to a process at step S12.

When the magnitude of the target lateral G is higher than the predetermined threshold (Yes at step S6), the driving assistance device 1 calculates deceleration G required when the vehicle 2 travels on the curve based on the curvature of the target trajectory in front (that is to say, the turning radius of the target trajectory) (step S7). At step S7, the driving assistance device 1 calculates the deceleration G by using the predetermined map and the predetermined equation as illustrated in FIG. 5, for example.

The driving assistance device 1 also calculates the target yaw rate required when the vehicle 2 travels on the curve based on the curvature of the target trajectory in front (that is to say, the turning radius of the target trajectory) (step S8). At step S8, the driving assistance device 1 calculates the target yaw rate by using the predetermined map and the predetermined equation as illustrated in FIG. 7, for example.

The driving assistance device 1 determines whether magnitude of the target yaw rate calculated at step S8 is higher than a predetermined threshold (step S9). At step S9, the driving assistance device 1 determines according to a determining equation “|γ_target|>γ_info”. In this determining equation, “|γ_target|” represents an absolute value indicating the magnitude of the target yaw rate and “γ_info” represents the threshold of the yaw rate serving as the determination reference for determining whether it is required to change the vehicle attitude by applying the braking force to the turning inner front wheel of the vehicle 2 for traveling on the target curve.

Herein, when the braking force is applied to the vehicle 2, a load is applied on the front side of the vehicle 2. Therefore, it becomes possible to effectively change the vehicle attitude by applying the braking force to the front wheel located on the front side of the vehicle 2 rather than by applying the braking force to the rear wheel. However, if the braking force is applied to the front wheel for all the curves, it is considered that a consumption degree of the brake of the front wheel becomes higher than that of the rear wheel. Therefore, in this embodiment, it is controlled such that the braking force is applied to the front wheel in a case of the sharp curve which the vehicle cannot turn unless the braking force is applied to the front wheel, and that the braking force is applied to the rear wheel in a case of the gentle curve appearing relatively often.

At step S9, when it is determined that the magnitude of the target yaw rate is higher than the predetermined threshold (Yes at step S9, it is determined that the curve is so sharp that the vehicle cannot turn unless the braking force is applied to the front wheel, and the driver of the vehicle 2 is notified that the trajectory control is being executed by the deceleration control on a single front wheel (step S10). For example, at step S10, the driving assistance device 1 allows the vehicle 2 to turn right while adjusting the speed by applying the braking force to the turning inner front wheel (right front wheel 3FR in FIG. 6(b)) by controlling the braking device 5 such that the vehicle 2 follows the target trajectory set along the sharp curve in the state in which the property of following the target trajectory by the steering control is improved as illustrated in FIG. 6(b). That is to say, the driving assistance device 1 notifies the driver of the vehicle 2 by the deceleration control on the turning inner front wheel of the change in the direction of movement and the travel speed of the vehicle 2 by the trajectory control when the target yaw rate is high as illustrated in FIG. 6 (b). Thereafter, this procedure is finished.

At step S9, when it is determined that the magnitude of the target yaw rate is lower than the predetermined threshold (No at step S9), it is determined that the curve is gentle such that the vehicle can turn without the braking force applied to the front wheel, and the driver of the vehicle 2 is notified that the trajectory control is being executed by the deceleration control on a single rear wheel (step S11). For example, at step S11, the driving assistance device 1 allows the vehicle 2 to turn right while adjusting the speed by applying the braking force to the turning inner rear wheel (right rear wheel 3RR in FIG. 6 (a)) by controlling the braking device 5 such that the vehicle 2 follows the target trajectory set along the gentle curve in the state in which the property of following the target trajectory by the steering control is improved as illustrated in FIG. 6(a). That is to say, the driving assistance device 1 notifies the driver of the vehicle 2 by the deceleration control on the turning inner rear wheel of the change in the direction of movement and the travel speed of the vehicle 2 by the trajectory control when the target yaw rate is low as illustrated in FIG. 6(a). Thereafter, this procedure is finished.

Herein, returning to step S6, this procedure is continuously described. When it is determined that the magnitude of the target lateral G is lower than the predetermined threshold at step S6 (No at step S6), the driving assistance device 1 executes notification control by steering (step S12). At step S12, it is determined that the vehicle 2 may travel on the target curve while maintaining the travel speed thereof without adjusting the speed, so that the driving assistance device 1 performs the trajectory control such that the vehicle 2 follows the target trajectory set along the gentle curve by the steering control as illustrated in FIG. 4(a), for example. That is to say, the driving assistance device 1 notifies the driver of the vehicle 2 by the steering control of the change in the direction of movement of the vehicle 2 by the trajectory control at the time of the travel to follow the target trajectory set along the gentle curve at a constant speed as illustrated in FIG. 4(a). Thereafter, this procedure is finished.

Furthermore, returning to step S4, this procedure is continuously described. When it is determined that there is no curve in front of the vehicle 2 at step S4 (No at step S4), the driving assistance device 1 determines whether a current state of the vehicle 2 is a state requiring the acceleration/deceleration control (step S13).

At step S13, the driving assistance device 1 determines whether the vehicle 2 is in the state of requiring the acceleration/deceleration based on the inter-vehicular distance from the vehicle in front generated based on the detection result detected by the travelable region detecting device and difference between a current travel speed and the target vehicle speed and the like. For example, the driving assistance device 1 determines that the vehicle 2 should be accelerated when the inter-vehicular distance from the vehicle in front which is traveling in front of the vehicle 2 is relatively long or when the current travel speed does not reach the target vehicle speed. The driving assistance device 1 determines that the vehicle 2 should be decelerated when the inter-vehicular distance from the vehicle in front which is traveling in front of the vehicle 2 is relatively short or when the current travel speed is higher than the target vehicle speed. The driving assistance device 1 determines that the vehicle 2 is not required to be accelerated/decelerated when the inter-vehicular distance from the vehicle in front traveling in front of the vehicle 2 is maintained at an appropriate distance or when the current travel speed is maintained at the target vehicle speed.

When it is determined that the acceleration/deceleration control is not required (No at step S13), the driving assistance device 1 shifts to step S12 and executes the notification control by the steering. In this case, the driving assistance device 1 turns to modify the vehicle 2 which slants by the disturbance such as the unevenness of the road surface and the wind by the steering control such that the vehicle 2 follows the target trajectory set for the straight travel as illustrated in FIG. 3(a), for example. That is to say, the driving assistance device 1 notifies the driver of the vehicle 2 by the steering control of the change in the direction of movement of the vehicle 2 by the trajectory control at the time of the travel to follow the target trajectory set for the straight travel at the constant speed as illustrated in FIG. 3(a). Thereafter, this procedure is finished.

When it is determined that the acceleration/deceleration control is required (Yes at step S13), the driving assistance device 1 determines whether magnitude of acceleration/deceleration G calculated so as to realize the target vehicle speed of the vehicle 2 in the state in which the acceleration/deceleration control is required determined at step S13 is higher than a predetermined threshold (step S14). At step S14, the driving assistance device determines according to a determining equation “|acceleration/deceleration G|>Gx_info”. In this determining equation “|acceleration/deceleration G|” represents an absolute value indicating the magnitude of the acceleration/deceleration G and “Gx_info” represents the threshold of the acceleration/deceleration G serving as a determination reference for determining whether the driver of the vehicle 2 may feel that the trajectory control is being executed by the longitudinal motion by the acceleration/deceleration.

When it is determined that the magnitude of the acceleration/deceleration G is higher than the predetermined threshold (Yes at step S14), the driving assistance device 1 executes the notification control by both wheel acceleration/deceleration (step S15). At step S15, the driving assistance device 1 performs the trajectory control such that the vehicle 2 follows the target trajectory set for the straight travel by the deceleration control in the state in which the property of following the target trajectory by the steering control is improved when the degree of change in the travel speed by the trajectory control is high as illustrated in FIG. 3(c), for example. That is to say, the driving assistance device 1 notifies the driver of the vehicle 2 by the deceleration control of the change in the travel speed of the vehicle 2 by the trajectory control at the time of the travel to follow the target trajectory set for the straight travel at the target speed set so as to decelerate as illustrated in FIG. 3(c). Meanwhile, at step S15, the driving assistance device 1 may notify the driver of the vehicle 2 by the acceleration control of the change in the travel speed of the vehicle 2 by the trajectory control at the time of the travel to follow the target trajectory set for the straight travel at the target speed set so as to accelerate. Thereafter, this procedure is finished.

When it is determined that the magnitude of the acceleration/deceleration G is lower than the predetermined threshold (No at step S14), the driving assistance device 1 executes the notification control by the steering and the acceleration/deceleration (step S16). At step S16, the driving assistance device 1 performs the trajectory control such that the vehicle 2 follows the target trajectory set for the straight travel by the steering control in a case in which the degree of change in the travel speed by the trajectory control is low as illustrated in FIG. 3(b), for example. That is to say, the driving assistance device 1 notifies the driver of the vehicle 2 by the steering control of the change in the direction of movement of the vehicle 2 by the trajectory control at the time of the travel to follow the target trajectory set for the straight travel at the target speed set so as to slowly decelerate as illustrated in FIG. 3(b). Meanwhile, at step S16, the driving assistance device 1 may also notify the driver of the vehicle 2 by the steering control of the change in the direction of movement of the vehicle 2 by the trajectory control at the time of the travel to follow the target trajectory set for the straight travel at the target speed set so as to slowly accelerate. In this manner, although the notification control by the steering and the acceleration/deceleration is executed at step S16, the degree of change in the acceleration/deceleration is not high enough for the driver of the vehicle 2 to easily, feel, so that the driver of the vehicle 2 is substantially notified that the trajectory control is being executed by the lateral motion by the steering control. Thereafter, this procedure is finished.

### REFERENCE SIGNS LIST

1 DRIVING ASSISTANCE DEVICE
2 VEHICLE
3 WHEEL
4 DRIVING DEVICE (TRAVEL CONTROL DEVICE)
5 BRAKING DEVICE (TRAVEL CONTROL DEVICE)
6 STEERING DEVICE (TRAVEL CONTROL DEVICE)
7 ECU (CONTROL DEVICE)
8a ACCELERATOR PEDAL
8b BRAKE PEDAL
9 FRONT WHEEL STEERING DEVICE
9a STEERING WHEEL
9b TURNING ANGLE APPLYING MECHANISM
9c VGRS DEVICE
9d STEERING DRIVER
10 REAR WHEEL STEERING DEVICE
10a STEERING DRIVER
11 WHEEL SPEED SENSOR
12 WHEEL CYLINDER PRESSURE SENSOR
13 FRONT PART DETECTING DEVICE (TRAVELABLE REGION DETECTING DEVICE)

1. A driving assistance device comprising:
a travelable region detecting device which detects a travelable region of a vehicle;
a travel control device which executes trajectory control by at least one of steering control and acceleration/deceleration control based on a target trajectory generated such that the vehicle travels in the travelable region detected by the travelable region detecting device; and
a control device which improves control accuracy of the steering control so as to improve a property of following the target trajectory at a time the acceleration/deceleration control is required as compared to a case in which the acceleration/deceleration control is not required at a time of execution of the trajectory control by the travel control device.

2. The driving assistance device according to claim 1, wherein it is determined whether the acceleration/deceleration control is required based on at least one of a turning radius of the target trajectory, a road gradient of a travel path, and a target vehicle speed.

3. The driving assistance device according to claim 1, wherein the control device controls to notify a driver of the vehicle by the acceleration/deceleration control that the trajectory control is being executed in a state in which the property of following the target trajectory is improved.

4. The driving assistance device according to claim 3, wherein the control device calculates a target yaw rate based on the turning radius of the target trajectory, controls to make a ratio of braking force of a turning inner rear wheel to braking force of a turning inner front wheel of the vehicle larger as the target yaw rate is lower, and notifies the driver of the vehicle that the trajectory control is being executed by the acceleration/deceleration control.

5. A driving assistance method executed in a driving assistance device including: a travelable region detecting device which detects a travelable region of a vehicle; a travel control device which executes trajectory control by at least one of steering control and acceleration/deceleration control based on a target trajectory generated such that the vehicle travels in the travelable region detected by the travelable region detecting device; and a control device, the driving assistance method comprising
improving, by the control device, control accuracy of the steering control so as to improve a property of following the target trajectory at a time the acceleration/deceleration control is required as compared to a case in which the acceleration/deceleration control is not required at a time of execution of the trajectory control by the travel control device.

6. The driving assistance device according to claim 2, wherein the control device controls to notify a driver of the vehicle by the acceleration/deceleration control that the trajectory control is being executed in a state in which the property of following the target trajectory is improved.

7. The driving assistance device according to claim 6, wherein the control device calculates a target yaw rate based on the turning radius of the target trajectory, controls to make a ratio of braking force of a turning inner rear wheel to braking force of a turning inner front wheel of the vehicle larger as the target yaw rate is lower, and notifies the driver of the vehicle that the trajectory control is being executed by the acceleration/deceleration control.
